(19) United States
(12) Patent Application Publication
(10) Pub. No.: US 2026/0062323 A1
(43) Pub. Date: Mar. 5, 2026

(54) METHOD FOR IMPROVING ELECTROCHEMICAL OXIDATIVE DESTRUCTION OF RECALCITRANT CONTAMINANTS

(71) Applicant: Faraday Technology, Inc., Englewood, OH (US)

(72) Inventors: Katherine Lee, Dayton, OH (US); Huong Le, Dayton, OH (US); Timothy D. Hall, Englewood, OH (US); Maria E. Inman, Yellow Springs, OH (US)

(21) Appl. No.: 19/314,075

(22) Filed: Aug. 29, 2025

Related U.S. Application Data
(60) Provisional application No. 63/689,900, filed on Sep. 3, 2024.

(51) Int. Cl. C02F 1/467; B09C 1/08; C02F 1/461; C02F 101/36

(52) U.S. Cl. CPC C02F 1/4672; B09C 1/085; C02F 2001/46119; C02F 2101/36; C02F 2201/4613; C02F 2201/46135; C02F 2201/46175

(57) ABSTRACT

An electrochemical oxidative method destroys recalcitrant contaminants in an aqueous solution. The aqueous solution is directed to an electrochemical reactor with an anode and a cathode. A pulsating voltage is delivered across the anode and cathode generating a pulsating current to decrease energy consumption urging the recalcitrant contaminants in the aqueous solution to contact the anode and breaking strong bonds of the recalcitrant contaminants when they contact the anode.

### RELATED APPLICATIONS

This application claims benefit of and priority to U.S. Provisional Application Ser. No. 63/689,900 filed Sep. 3, 2024, under 35 U.S.C. §§ 119, 120, 363, 365, and 37 C.F.R. § 1.55 and § 1.78, which is incorporated herein by this reference.

### GOVERNMENT RIGHTS

This invention was made with U.S. Government support under Contract Nos. 6HERC20C0058 and 6HERC20C0054 awarded by the Environmental Protection Agency. The Government has certain rights in the subject invention.

### FIELD OF THE INVENTION

The present invention relates to methods and systems for the electrochemical oxidative destruction of recalcitrant chemicals in polluted water.

### BACKGROUND OF THE INVENTION

The electrochemical technology disclosed herein addresses the need for technologies for economical destruction of recalcitrant contaminants in complex aqueous solutions (e.g., industrial wastewater, groundwater, landfill leachate, drinking water, etc.) without the formation of toxic by-products. Of specific interest are electroactive recalcitrant chemicals that are environmentally persistent, bio-accumulative, have the potential to cause adverse health effects, and are largely impervious to common biological degradation and conventional chemical oxidation processes used in water treatment. Many such chemicals have very strong molecular bonds, e.g., carbon-fluorine bonds.

Electroactive recalcitrant chemicals have the potential to be destroyed via electrochemical oxidation. Electrochemical oxidation uses electrical power applied to an electrode to drive electron transfer reactions that decompose the recalcitrant contaminant into environmentally benign products. Destruction may proceed via direct electron transfer between the contaminant and the electrode surface and/or indirect electrochemical oxidation. For the indirect destruction pathway, electrochemical oxidation generates radicals which mediate destruction of the recalcitrant contaminant. Advantages of electrochemical oxidation technology include operation at ambient conditions, the ability to be deployed on-site in mobile units, and avoiding the use of auxiliary chemicals. Electrochemical oxidation destruction technology has been demonstrated at the bench and pilot scale for a variety of recalcitrant contaminants. Several companies are pursuing commercialization of electrochemical oxidative destruction either as a stand-alone destruction technology or as part of a treatment train.

While significant strides have been made towards the development and deployment of electrochemical oxidation destruction systems, several challenges exist.

One key challenge is the high applied voltages/current densities needed to drive adequate rates of recalcitrant contaminant destruction. In conventional electrochemical oxidative destruction, a constant high anodic voltage is applied throughout water treatment. At the high voltages needed for recalcitrant contaminant destruction, mass transfer limitations result in very low current efficiencies for contaminant destruction, with the bulk of the current going towards the oxygen evolution reaction. These poor current efficiencies lead to high energy consumption and, by extension, operating costs.

Depending on the solution components, these high, constant voltages may also drive side reactions that generate toxic by-products (e.g., chlorate) and/or species that can interfere with recalcitrant contaminant destruction performance (e.g., precipitation reactions that lead to electrode fouling and/or obstruct solution flow). Mass transfer limitations and undesired side production formation will be most pronounced when working at low contaminant concentrations or in concentrated brines, where formation of organohalogen byproducts is more likely.

One way to enhance process performance is to provide a higher mass transfer rate. While increasing the electrode surface area can reduce mass transfer limitations, this high electrode surface area also implies higher capital costs for treatment.

### BRIEF SUMMARY OF THE INVENTION

The problem of destruction of recalcitrant contaminants including per- and polyfluoroalkyl substances (PFAS) such as perfluorooctane sulfonate (PFOS), perfluorooctanoic Acid (PFOA), perfluorobutane sulfonate (PFBS), perfluorohexane sulfonate (PFHxS), perfluorononanoic acid (PFNA), AND hexafluoropropylene oxide dimer acid (HFPO-DA) and other harmful organics contaminants such as pharmaceuticals released from manufacturing processes waste storage and treatment sites present in aqueous solutions including solutions used to remove recalcitrant contaminants from contaminated solid media (e.g., soil, sediment, contaminated adsorbent media, asphalt) in electrochemical reactors with one or more high voltage window electrodes (including boron doped diamond electrodes or Magneli phase titanium oxide electrodes) by direct current or constant voltage electrochemical oxidative (EO) treatment wherein the use of direct current or constant voltage results in low contaminant destruction rates, high operating costs, high capital costs, and/or toxic by-product formation, including perchlorate formation, is solved by operating said electrochemical reactor in either a flow-by or flow-through mode under pulsating voltage conditions with appropriately selected pulse voltage amplitude and appropriately selected pulse voltage on-time and off-time to increase contaminant destruction rate by at least 55% and reduce energy consumption by at least 65% and optionally adding a reverse voltage pulse to ameliorate electrode fouling or optionally switching the polarity of the electrodes in said electrochemical reactor or a combination of adding a reverse pulse and switching the electrode polarity and optionally substituting the cathode in said electrochemical reactor with an oxygen reducing gas diffusion electrode.

The feasibility of the invention has been demonstrated. Electrochemical oxidative destruction of acetaminophen and PFAOS (including PFOS, PFOA, PFBS, PFHxS, PFNA, and/or HFPO-DA) was evaluated using constant and pulsed-voltage conditions using boron doped diamond electrodes. For given applied voltages, improvements in the destruction rate and/or operating costs for electrochemical oxidative destruction was achieved by pulsating the voltage during treatment.

The limitations of constant voltage electrochemical oxidative destruction have been alleviated by the use of pulsed-voltage electrochemical oxidation. By interrupting the applied voltage with periods of no or low applied voltage, pulsed-voltage electrochemical oxidation is able to achieve a targeted degree of recalcitrant contaminant destruction while avoiding parasitic side reactions. The method may include an optional switching of the electrode polarity in the electrochemical reactor. This has the effect of enhancing mass transport, decreasing energy requirements/operating costs, mitigating formation of by-products that may be toxic or interfere with reactor operation, and preventing electrode scaling and fouling.

Featured is an electrochemical oxidative method of destroying recalcitrant contaminants in an aqueous solution wherein the aqueous solution is directed to an electrochemical reactor with an anode and a cathode. A pulsating voltage is delivered across the anode and cathode generating a pulsating current to decrease energy consumption. The recalcitrant contaminants in the aqueous solution are urged to contact the anode strong bonds of the recalcitrant contaminants are broken when they contact the anode. The method may further include reversing the pulsating voltage to clean the anode.

The pulsating voltage may have a voltage amplitude of between 5-20 Volts, duty cycles of between 10-50%, and/or a frequency of between 5-200 Hz. The recalcitrant contaminants may include per- and polyfluoroalkyl substances (PFAS) including perfluorooctane sulfonate (PFOS), perfluorooctanoic Acid (PFOA), perfluorobutane sulfonate (PFBS), perfluorohexane sulfonate (PFHxS), perfluorononanoic acid (PFNA), AND hexafluoropropylene oxide dimer acid (HFPO-DA) and other harmful organics contaminants including pharmaceuticals released from manufacturing processes, waste storage and treatment sites, present as aqueous solutions including solutions used to remove recalcitrant contaminants from contaminated solid media.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of one embodiment of an electrochemical reactor for electrochemical oxidative destruction of recalcitrant contaminants in aqueous solution;

FIG. 2 is a schematic view of another example of an electrochemical reactor for electrochemical oxidative destruction of recalcitrant contaminants in aqueous solution;

FIG. 3 illustrates a generic pulse waveform;

FIG. 4 illustrates a generic pulse reverse waveform;

FIG. 5 illustrates the percent of contaminant (acetaminophen) destroyed as a function of duty cycle for pulsed-voltage and constant voltage electrochemical oxidation under the conditions of Working Example 1;

FIG. 6 illustrates the energy required to reduce the acetaminophen concentration by one order of magnitude as a function duty cycle for the experiments plotted in FIG. 5;

FIG. 7 illustrates the percent of contaminant (PFOS) destroyed as a function of the energy required to reduce the PFOS concentration by one order of magnitude for pulsed-voltage and constant voltage electrochemical oxidation under the conditions of Working Example 2;

FIG. 8 illustrates the percent of contaminant (PFOS) destroyed as a function of the energy required to reduce the PFOS concentration by one order of magnitude for pulsed-voltage and constant voltage electrochemical oxidation under the conditions of Working Example 3.

FIG. 9 illustrates the percent of contaminant (PFOS) destroyed as a function of the energy required to reduce the PFOS concentration by one order of magnitude for pulsed-voltage and constant voltage electrochemical oxidation under the conditions of Working Example 4;

FIG. 10 illustrates the percent of contaminant (PFOS) destroyed as a function of treatment time for pulsed-voltage and constant voltage electrochemical oxidation under the conditions of Working Example 5;

FIG. 11 illustrates the energy required to reduce the PFOS concentration by one order of magnitude as a function of time for the experiments plotted in FIG. 10;

FIG. 12 illustrates the percent of contaminant (PFOS) destroyed as a function of treatment time for pulsed-voltage and constant voltage electrochemical oxidation under the conditions of Working Example 6; and

FIG. 13 illustrates the energy required to reduce the PFOS concentration by one order of magnitude as a function of time for the experiments plotted in FIG. 12.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

Provided is a method for enhancing the performance of direct current or constant voltage electrochemical oxidative destruction of recalcitrant contaminants through the use of pulse current or pulsed-voltage electrochemical oxidation. In the electrochemical oxidative destruction method, electron transfer reactions between an anode and solubilized chemical species drives destruction of the solubilized recalcitrant contaminant. Electrochemical oxidative destruction can proceed via either direct oxidation or indirect oxidation. In direct oxidation, the recalcitrant contaminant is first adsorbed onto the anode and electron transfer from the recalcitrant contaminant to the anode drives contaminant destruction. In the indirect oxidation pathway, oxidation reactions at the anode generate oxidants which mediate oxidation of the recalcitrant contaminant. The mechanism and efficacy of electrochemical oxidative destruction will depend on the chemical properties of the recalcitrant contaminant, the solution properties, as well as the properties of the anode, such as O₂ overpotential, adsorptive properties.

When a voltage or current is applied to the anode, the recalcitrant contaminants in the case of direct oxidation or oxidant precursor in the case of indirect oxidation are oxidized at the anode surface. Consequently, the concentration of the recalcitrant contaminant or oxidant precursor at the anode surface is depleted and a concentration gradient is established between the anode surface where the contaminant or oxidant precursor is depleted and the bulk solution where the contaminant or oxidant precursor concentration is high. The layer of depleted and variable recalcitrant contaminant or oxidant precursor concentration is known as the Nernst diffusion layer or boundary layer. Recalcitrant contaminants or oxidant precursors must diffuse from the bulk solution to the anode surface before electrochemical oxidative destruction can continue. The absence of recalcitrant contaminants or oxidant precursors enables the oxidation of other species at the anode surface (e.g., chloride, bromide). These parasitic side reactions decrease the energy efficiency of the reaction and have the potential to generate toxic by-products (e.g., perchlorate). In addition, the rate of the oxidative reaction is limited by mass transport to the vicinity of the electrode. Consequently, it can be seen that an improvement in the performance of electrochemical oxidative destruction can be achieved by enhancing mass transfer of recalcitrant contaminants or oxidant precursors to the anode surface.

In direct current or constant voltage electrochemical oxidation, the Nernst diffusion layer will rapidly reach a time-invariant steady-state thickness this is dependent on the magnitude of the applied voltage or current and solution hydrodynamics. However, the ability to control mass transport by varying the magnitude of the applied voltage or current is limited by the high voltages needed to oxide the contaminant or form the oxidant. Mass transport can also be improved by using more hydrodynamically turbulent conditions such as operating electrochemical oxidative destruction in flow-through set-ups with perforated electrodes. However, even under hydrodynamically turbulent conditions, the transport of recalcitrant contaminant or oxidant precursor from the bulk solution to the electrode is limited by its diffusion in the Nernst diffusion layer.

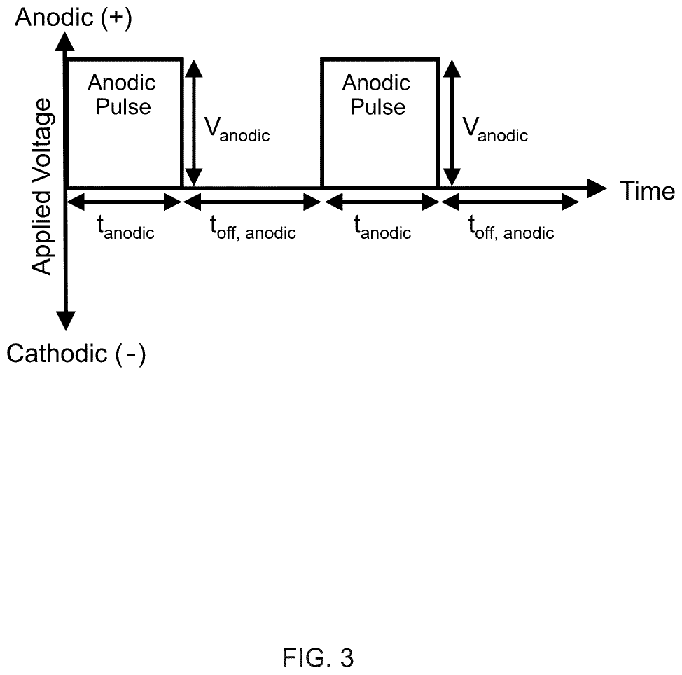

This method preferably uses pulse current or pulsed-voltage electrochemical oxidation to improve the performance of electrochemical oxidative destruction relative to direct current or constant voltage electrochemical oxidation. FIG. 3 schematically illustrates a pulsed voltage (or current) used in this invention. An anodic peak voltage (V_{anodic}) is turned on for a period of time (t_{anodic}) called the on-time, followed a period of time (t_{off,anodic}) where no or low voltage (or current) is applied to the anode called the off-time, consisting of a cathodic (forward) pulse followed by an anodic (reverse) pulse and an off-time. The sum of on-time and off-time is known as the period of the pulse and the inverse of the period is known as the frequency of the pulse. The percent on-time in a pulse is defined as the duty-cycle (Dc) of the pulse. As discussed in the prior art U.S. Pat. Nos. 5,599,437; 6,524,461; 6,652,727; 6,863,793; 6,878,259; 7,022,216; 11,527,782; 11,702,759 which are incorporated herein by reference, the advantage of the pulse current or pulsed-voltage electrochemical oxidation is that the applied current or voltage can be interrupted before the Nernst diffusion layer has a chance to reach the steady-state value.

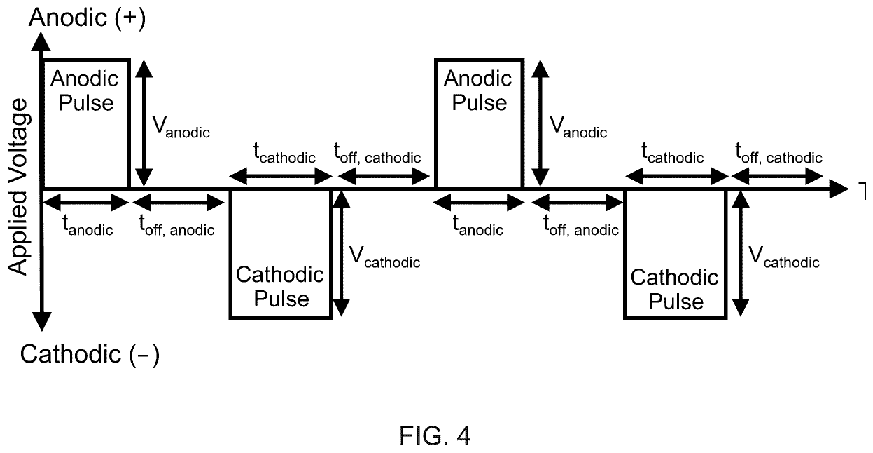

This allows the recalcitrant chemicals or oxidant precursors to diffuse back to the electrode surface and replenishes the surface concentration of these species before the next pulse. By careful tuning of the anodic pulse and off-time, it is possible to maximize recalcitrant contaminant destruction while minimizing parasitic side reactions, thereby improving the energy efficiency of electrochemical oxidative destruction and mitigating toxic by-product formation. For recalcitrant contaminants with anionic groups (e.g., PFOS), potential benefits of including a low-voltage (or current) during the anodic off-time is to enhance the concentration of recalcitrant contaminant at the electrode surface via electrostatic interactions between the electrode and anionic group. As shown in FIG. 4, the method may include an optional switching of the electrode polarity in the electrochemical parameter. A cathodic peak voltage (V_{cathodic}) is applied for a period of time (t_{cathodic}). This cathodic pulse can be followed by a period of time (t_{off,cathodic}) where no or low-voltage (or current) is applied. Potential benefits of reversing polarity include preventing scaling and fouling at the cathode.

The following examples illustrate various embodiments. The disclosure will be discussed in terms of mixed metal oxide (MMO) anodes for destruction of acetaminophen and boron doped diamond (BDD) anodes for destruction of PFAS, i.e., the destruction of the strong carbon/fluorine bonds thereof. However, it will be understood by those skilled in the art that the invention is applicable to any combination of recalcitrant chemical, solution properties, and anode material in which electrochemical oxidation reactions leads to destruction of a recalcitrant contaminant.

In the following examples, the improved performance of the invention will be discussed in terms of the energy efficiency of recalcitrant contaminant destruction. However, it will be understood by those skilled in the art that the improved mass transfer enabled by the invention can achieve other performance enhancements (e.g., reduction of toxic by-product formation). The energy efficiency will be described in terms of the electrical energy required to decrease the concentration of recalcitrant contaminant by one order of magnitude in a unit volume of contaminated solution (Ē). The equations describing the energy requirements for an electrochemical oxidation reactor are:

$$\overline{E} = \frac{E}{V log ( \frac{{C}_{o}}{{C}_{t}} )}$$

where (m³) is the volume of the reaction solution, where C₀ is the substrate concentration at time zero, C₀ is the substrate concentration at a reaction time t, and E is the energy consumed during treatment (kWh), calculated as:

$$E = {Φ}_{p} {I}_{a} t$$

where Φₚ is the peak voltage, Iₐ is the average current, t is the treatment duration.

During electrochemical oxidative destruction, the solution containing recalcitrant contaminants is pumped from a solution reservoir into an electrochemical reactor containing at least one high voltage electrode (to be used as the anode) and a counter electrode. In the electrochemical reactor, the solution may be flowed by or (for porous electrodes) through the electrodes. A power supply applies a voltage to the electrodes of the system. At sufficiently high applied voltages, electrochemical oxidation drives the destruction of the recalcitrant contaminant. The solution may then be pumped into a secondary collection reservoir or back into the starting solution reservoir, where it is available for further treatment.

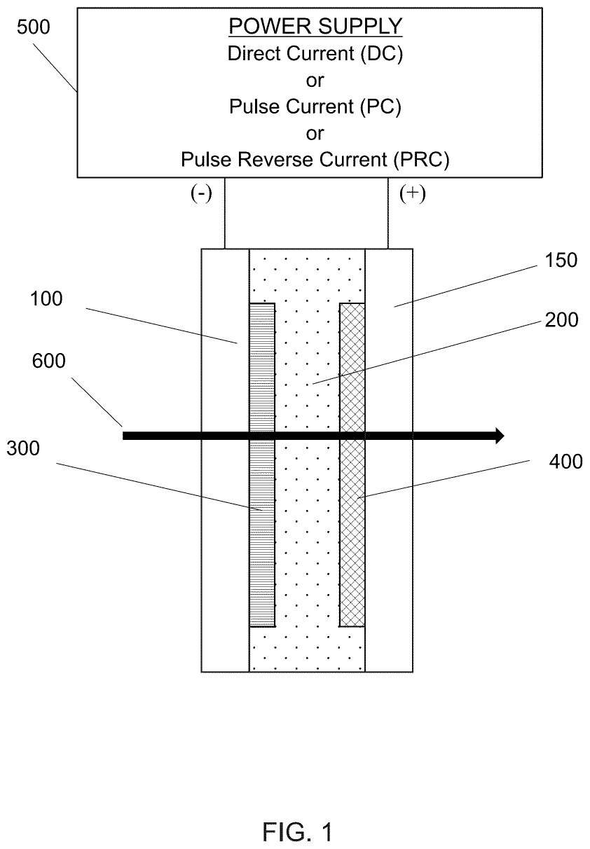

FIG. 1 shows one embodiment of an electrochemical reactor for electrochemical oxidative destruction of recalcitrant contaminants. This reactor was used for acetaminophen destruction under the conditions of Working Example 1. The reactor design includes an electrically conductive cathode endplate (100) fabricated from titanium, an electrically conductive anode endplate (150) and an electrically insulating central plate (200) fabricated chlorinated polyvinyl chloride (CVPC) plate. The central square chamber of the electrically insulating central plate (200) was framed by a square recess on both sides of the plate which housed the cathode (300) fabricated from porous carbon felt and anode (400) fabricated from porous mixed metal oxide (MMO) mesh, respectively. Rectifier (500) capable of delivering a direct voltage (or current), or pulse voltage (or current) or pulse reverse voltage (or current) waveform is connected. During operation, the contaminant-containing (acetaminophen) electrolyte flow (600) enters into a flow channel in the titanium electrically conducting cathode endplate (100) that is adjacent to the carbon felt cathode (300). The solution then flows through the carbon felt cathode (300), the CVPC electrically insulating central plate (200), and mesh MMO anode (400) before exiting through flow channel in the titanium electrically conducting anode endplate (150) adjacent to the mesh MMO anode. After exiting the reactor, the contaminant-containing (acetaminophen) electrolyte (600) is flowed into a second collection beaker.

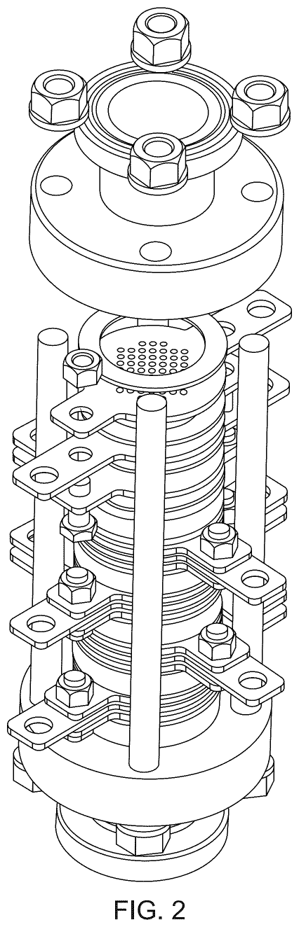

FIG. 2 shows a second embodiment of an electrochemical reactor for electrochemical oxidative destruction of recalcitrant contaminants. This reactor was used for PFOS destruction under the conditions of Working Example 2, 3, 4, 5, and 6. This reactor is the subject of U.S. Patent Publication No. 2018/0099881 (now U.S. Pat. No. 11,008,231) incorporated herein by this reference. The electrochemical reactor is commercially available from CONDIAS GmbH as CONDIALCELL® Cell Model ECWP D20 5P. The CONDIACELL® utilized commercially available boron-doped diamond for both the cathode and anode commercially available as DIACHEM® electrodes. During operation, the PFOS-containing electrolyte is flowed from a solution reservoir, through the reactor, and back into the solution reservoir. This closed-loop, multi-pass set-up enables re-circulation of the PFOS-containing solution through the electrochemical reactor.

### Working Example I

This example shows how Ē varies as a function of duty cycle for constant voltage and pulsed-voltage electrochemical oxidative destruction of acetaminophen using the single-pass reactor set-up of FIG. 1. Experiments were conducted using a constant flow rate (1.8 mL/min), initial acetaminophen concentration (˜36,750 ppb), and anodic voltage (6 V). All experiments used an electrolyte solution containing 50 mM Na₂SO₄ and 0.2 mM FeSO₄. All pulsed-voltage electrochemical oxidation trials used a frequency of 100 Hz. Five duty cycles were tested: 10%, 25%, 50%, 75%, and 100% (where 100% corresponds to constant voltage). The concentration of acetaminophen was quantified before and after each trial using HPLC/MS/MS. Results from these trials are summarized in Table I.

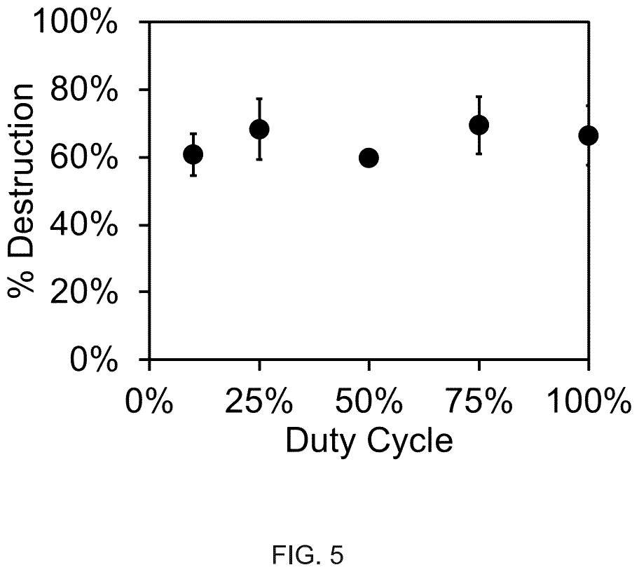

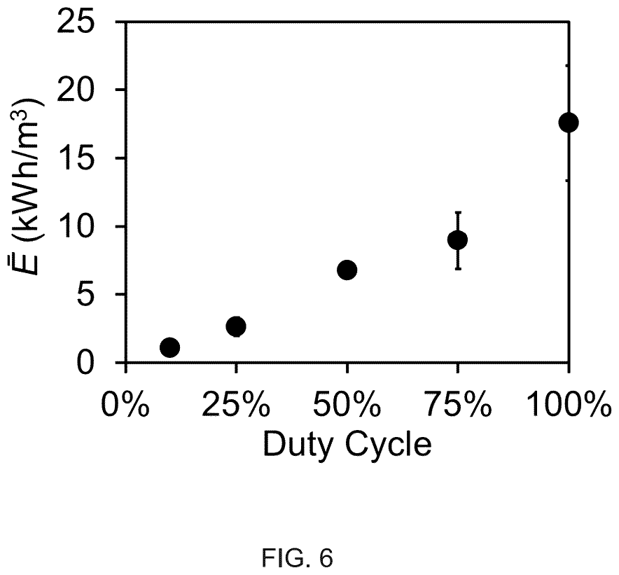

FIG. 5 plots % Destruction of acetaminophen as a function of duty cycle. At all duty cycles, a % Destruction between 60-70% is observed and no clear trend is observed between % Destruction and duty cycle. Specifically, 61% removal is achieved with a 10% duty cycle, 68% removal is achieved with a 25% duty cycle, 60% removal is achieved with a 50% duty cycle, 69% removal is achieved with a 75% duty cycle, and 66% removal is achieved with a 100% duty cycle. FIG. 6 plots Ē as a function of duty cycle. A clear relationship between Ē and duty cycle is observed, with Ē monotonically increasing from 1.1 kWh/m³ with a 10% duty cycle to 2.7 kWh/m³ with a 25% duty cycle to 6.9 kWh/m³ with a 50% duty cycle to 9.1 kWh/m³ with a 75% duty cycle to 17.9 kWh/m³ with a duty cycle of 100%.

These results show that decreasing the duty cycle enables the same % acetaminophen removal while decreasing Ē.

TABLE I
Results for electrochemical oxidative destruction of
acetaminophen in the single-pass reactor set-up of FIG. 1.
All experiments were conducted in a solution of 50 mM
Na₂SO₄ and 0.2 mM FeSO₄ and used a constant
flow rate (1.8 mL/min), initial acetaminophen
concentration (~36,750 ppb), and anodic voltage (6 V). All
pulsed-voltage experiments used a frequency of 100 Hz.

| Duty Cycle | Vₐᵥₑ | % Destroyed | Ē (kWh/m³) |
|---|---|---|---|
| 100% | 6 | 66 | 17.9 |
| 75% | 4.5 | 69 | 9.1 |
| 50% | 3 | 60 | 6.9 |
| 25% | 1.5 | 68 | 2.7 |
| 10% | 0.6 | 61 | 1.1 |

### Working Example II

This example compares the % Destruction and Ē for constant voltage and pulsed-voltage electrochemical oxidative destruction of PFOS using an anodic voltage of 8 V. Pulsed-voltage experiments varied the frequency and duty cycle while keeping the peak voltage constant 8 V. Experiments were conducted in the multi-pass reactor set-up of FIG. 2 using 7 liters of the electrolyte composition of Table II and a flow rate of 4 GPM. All trials were run for 30 minutes and the concentration of PFOS was quantified before and after each trial using HPLC/MS/MS. Experimental parameters and results from these trials are summarized in Table III.

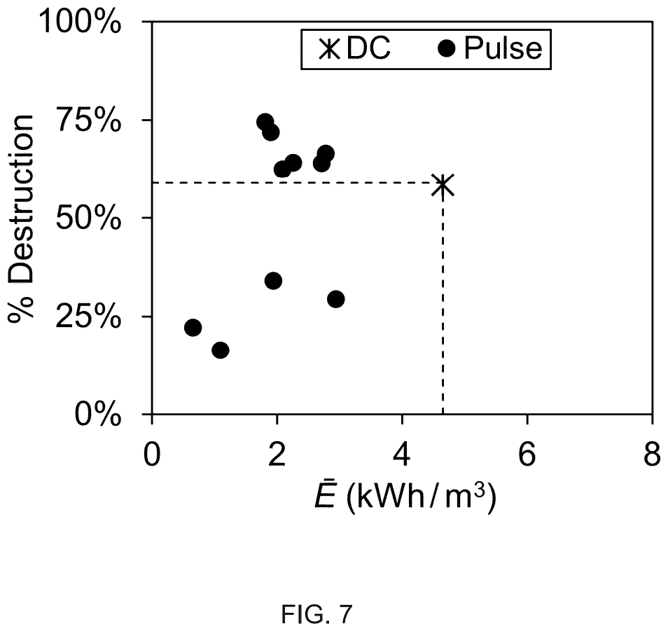

FIG. 7 shows how % Destruction varies as a function of Ē for the constant voltage and pulsed-voltage experiments. After 30 minutes of constant voltage treatment, 59% of PFOS was destroyed with an Ē of 4.65 kWh/m³. In all cases, the Ē for pulsed-voltage electrochemical oxidation was lower than the Ē for constant voltage electrochemical oxidation. Specifically, the Ē for pulsed-voltage electrochemical oxidation ranged from 0.66 kWh/m³ (duty cycle=5%, f=20 Hz) to 2.79 kWh/m³ (duty cycle=70%, f=200 Hz). Pulsed-voltage electrochemical oxidation with duty cycles ≥50% also achieved higher % Destruction of PFOS than constant voltage electrochemical oxidation. Specifically, the % Destruction for pulsed-voltage electrochemical oxidation with duty cycles ≥50% ranged from 62% (duty cycle-50%, f=5000 Hz) to 74% (duty cycle=50%, f=100 Hz). These results demonstrate that pulsed-voltage electrochemical oxidation with a peak voltage of 8 V can achieve higher % Destruction and lower Ē than constant voltage electrochemical oxidation at 8 V.

TABLE II
Electrolyte composition for Working Example 2 and 3.

| Chemical | Concentration |
|---|---|
| NaH₂PO₄ | 2.5 mM |
| KH₂PO₄ | 4.4 mM |
| Na₂HPO₄ | 5.2 mM |
| Na₂CO₃ | 0.2 mM |
| NaNO₃ | 0.5 mM |
| NaCl | 8.8 mM |
| NH₄Cl | 2.5 mM |
| CaCl₂ | 0.2 mM |
| MgCl₂ | 3.3 mM |
| Na₂SO₄ | 0.5 mM |

TABLE III
Results for destruction of PFOS using constant voltage and pulsed-
voltage electrochemical oxidation with an anodic voltage of 8
V. All experiments were conducted in the multi-pass reactor set-up
of FIG. 2, used 7 L of the electrolyte composition of Table II,
and employed a constant a constant flow rate (4 GPM).

| Duty Cycle | f (Hz) | Vₐᵥₑ | Ē (kWh/m³) | % Destruction |
|---|---|---|---|---|
| 5% | 20 | 0.4 | 0.66 | 22% |
| 5% | 200 | 0.4 | 1.10 | 16% |
| 20% | 200 | 1.6 | 2.95 | 29% |
| 20% | 2000 | 1.6 | 1.95 | 34% |
| 50% | 10 | 4 | 1.90 | 72% |
| 50% | 100 | 4 | 1.82 | 74% |
| 50% | 1000 | 4 | 2.26 | 64% |
| 50% | 5000 | 4 | 2.09 | 62% |
| 70% | 200 | 5.6 | 2.79 | 66% |
| 70% | 2000 | 5.6 | 2.72 | 64% |
| 100% | — | 8 | 4.65 | 59% |

### Working Example III

This example compares the % Destruction and Ē for constant voltage and pulsed-voltage electrochemical oxidative destruction of PFOS using an anodic voltage of 10 V. Pulsed-voltage experiments varied the frequency and duty cycle while keeping the peak voltage constant 10 V. Experiments were conducted in the multi-pass reactor set-up of FIG. 2 using 7 liters of the electrolyte composition of Table II and a flow rate of 4 GPM. All trials were run for 30 minutes and the concentration of PFOS was quantified before and after each trial using HPLC/MS/MS. Experimental parameters and results from these trials are summarized in Table IV.

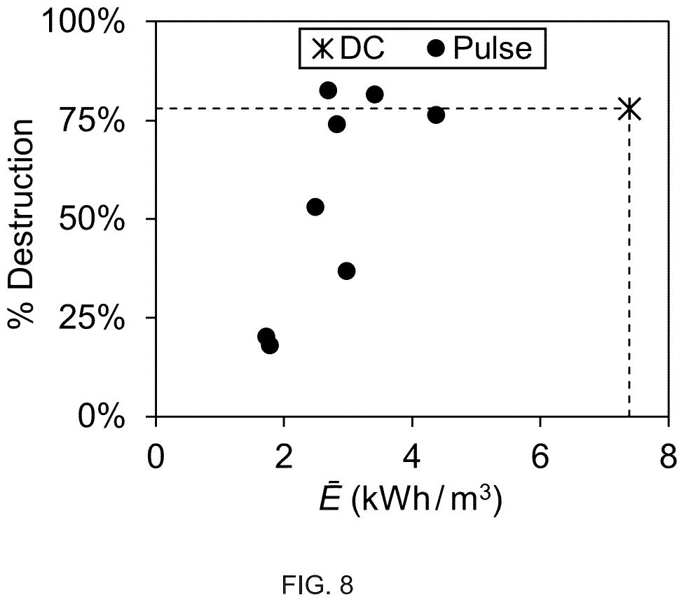

FIG. 8 shows how % Destruction varies as a function of Ē for the constant voltage and pulsed-voltage experiments. After 30 minutes of constant voltage treatment, 78% of PFOS was destroyed with an Ē of 7.39 kWh/m³. In all cases, the Ē for pulsed-voltage electrochemical oxidation was lower than the Ē for constant voltage electrochemical oxidation. Specifically, the Ē for pulsed-voltage electrochemical oxidation ranged from 1.73 kWh/m³ (duty cycle=5%, f=200 Hz) to 4.38 kWh/m³ (duty cycle=70%, f=20 Hz). Pulsed-voltage electrochemical oxidation with duty cycles ≥50% also achieved higher % Destruction of PFOS than constant voltage electrochemical oxidation. Specifically, the % Destruction for pulsed-voltage electrochemical oxidation with duty cycles ≥50% ranged from 74% (duty cycle=50%, f=5000 Hz) to 83% (duty cycle=70%, f=200 Hz). These results demonstrate that pulsed-voltage electrochemical oxidation with a peak voltage of 10 V can achieve higher % Destruction and lower Ē than constant voltage electrochemical oxidation at 10 V.

TABLE IV
Results for destruction of PFOS using constant voltage and pulsed-
voltage electrochemical oxidation with an anodic voltage of 10
V. All experiments were conducted in the multi-pass reactor set-up
of FIG. 2, used 7 L of the electrolyte composition of Table II,
and employed a constant a constant flow rate (4 GPM).

| Duty Cycle | f (Hz) | Vₐᵥₑ | Ē (kWh/m³) | % Destruction |
|---|---|---|---|---|
| 5% | 20 | 0.5 | 1.78 | 18% |
| 5% | 200 | 0.5 | 1.73 | 20% |
| 20% | 20 | 2 | 2.50 | 53% |
| 20% | 2000 | 2 | 2.98 | 37% |
| 50% | 5000 | 5 | 2.83 | 74% |
| 70% | 20 | 7 | 4.38 | 76% |
| 70% | 200 | 7 | 2.69 | 83% |
| 70% | 2000 | 7 | 3.42 | 82% |
| 100% | — | 10 | 7.39 | 78% |

### Working Example IV

This example compares the % Destruction and Ē for constant voltage and pulsed-voltage electrochemical oxidative destruction of PFOS using an anodic voltage of 8 V. Pulsed-voltage experiments varied the frequency while keeping the duty cycle (50%) and peak voltage (8 V) constant. Experiments were conducted in the multi-pass reactor set-up of FIG. 2 using 7 liters of the electrolyte composition of Table V and a flow rate of 4 GPM. All trials were run for 30 minutes and the concentration of PFOS was quantified before and after each trial using HPLC/MS/MS. Experimental parameters and results from these trials are summarized in Table III.

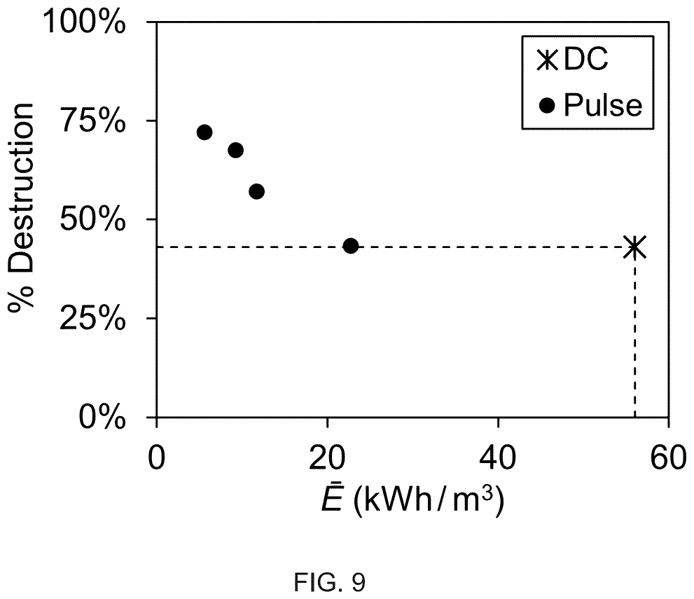

FIG. 9 shows how % Destruction varies as a function of Ē for the constant voltage and pulsed-voltage experiments. After 30 minutes of constant voltage treatment, 43% of PFOS was destroyed with an Ē of 56 kWh/m³. In all cases, the Ē for pulsed-voltage electrochemical oxidation was lower than the Ē for constant voltage electrochemical oxidation. Specifically, the Ē for pulsed-voltage electrochemical oxidation ranged from 5.9 kWh/m³ (duty cycle=50%, f=10 Hz) to 22.8 kWh/m³ (duty cycle=50%, f=5000 Hz). Pulsed-voltage electrochemical oxidation also achieved % Destruction of PFOS on par with or superior to constant voltage electrochemical oxidation. Specifically, the % Destruction for pulsed-voltage electrochemical oxidation ranged from 43% (duty cycle=50%, f=5000 Hz) to 72% (duty cycle=50%, f=10 Hz). These results demonstrate that pulsed-voltage electrochemical oxidation with a peak voltage of 8 V can achieve higher % Destruction and lower Ē than constant voltage electrochemical oxidation at 8 V.

TABLE V
Electrolyte composition for Working Example 4, 5, and 6.

| Chemical | Concentration |
|---|---|
| NaH₂PO₄ | 15 mM |
| KH₂PO₄ | 15 mM |
| NaNO₃ | 40 mM |
| KCl | 40 mM |
| NaCl | 100 mM |
| CaCl₂ | 15 mM |
| MgCl₂ | 15 mM |
| Na₂SO₄ | 15 mM |

TABLE VI
Results for destruction of PFOS using constant voltage and pulsed-
voltage electrochemical oxidation with an anodic voltage of 8
V. All experiments were conducted in the multi-pass reactor
set-up of FIG. 2, used 7 L of the electrolyte composition of
Table V, and employed a constant a constant flow rate (4 GPM).

| Duty Cycle | f (Hz) | Vₐᵥₑ | Ē (kWh/m³) | % Destruction |
|---|---|---|---|---|
| 50% | 10 | 4 | 5.9 | 72% |
| 50% | 100 | 4 | 8.9 | 67% |
| 50% | 1000 | 4 | 12.3 | 57% |
| 50% | 5000 | 4 | 22.8 | 43% |
| 100% | — | 8 | 56 | 43% |

### Working Example V

This example compares the PFOS destruction performance of constant voltage (anodic voltage=8 V) and pulsed-voltage (peak voltage=8 V, duty cycle=20%, frequency=80 Hz) electrochemical oxidative destruction of PFOS over time. Experiments were conducted in the multi-pass reactor set-up of FIG. 2 using 8 liters of the electrolyte composition of Table V and a flow rate of 4 GPM. Experiments were run for 24 hours and aliquots of solution for HPLC/MS/MS analysis were collected before each trial and after 30 minutes, 2 hours, 8 hours, and 24 hours of treatment. Experimental results are summarized in Table III.

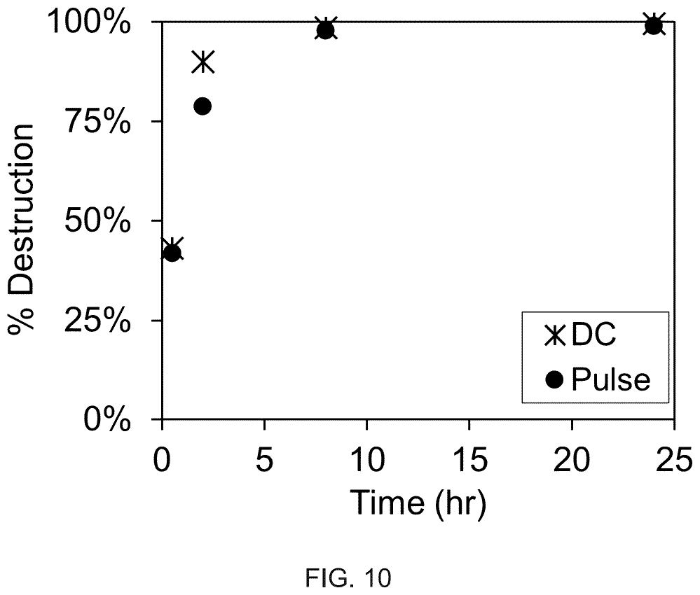

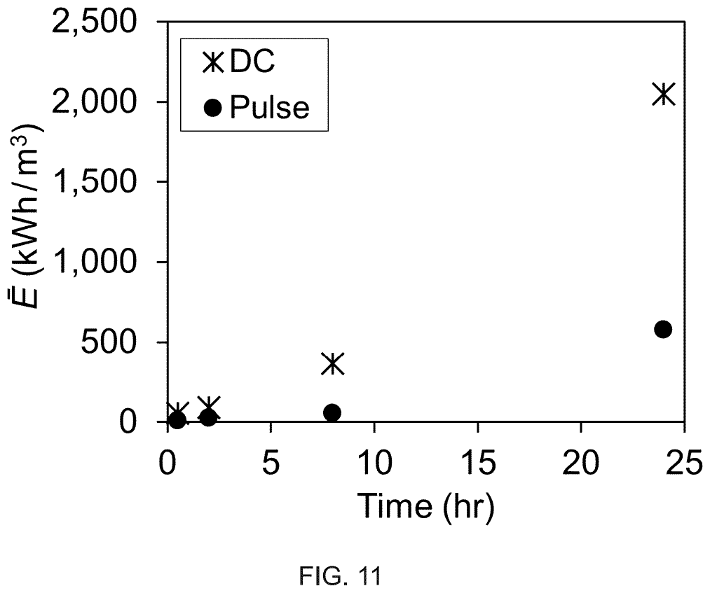

FIG. 10 shows how % Destruction varies as a function of time for the constant voltage and pulsed-voltage experiments. Comparing constant voltage treatment and pulsed-voltage treatment at each timepoint shows that both constant voltage and pulsed-voltage electrochemical oxidation achieve a comparable level of PFOS destruction. FIG. 11 shows how Ē varies as a function of time for the constant voltage and pulsed-voltage experiments. For both the constant voltage and pulsed-voltage experiments, Ē monotonically increases as a function of time, from 56 to 2049 kWh/m³ for constant voltage electrochemical oxidation and from 9.1 to 576 kWh/m³ for pulsed-voltage electrochemical oxidation waveform. However, at all timepoints, the Ē for the pulsed-voltage waveform is consistently 3.5-6.7× lower than for the DC waveform. These results demonstrate that, the 20% duty cycle, 80 Hz pulsed-voltage waveform with a peak voltage of 8 V can achieve a comparable % Destruction and lower Ē than constant voltage electrochemical oxidation with a voltage of 8 V.

TABLE VII
Results for long-timescale experiments in which PFOS
destruction performance was monitored as a function of time
at a constant voltage (8 V) and using a pulsed-voltage (8 V,
duty cycle = 20%, frequency = 80 Hz). All experiments were
conducted in the multi-pass reactor set-up of FIG. 2, used 7 L
of the electrolyte composition of Table V, and employed a
constant a constant flow rate (4 GPM).

| | % Destruction | | Ē (kWh/m³) | |
|---|---|---|---|---|
| | Constant | | Constant | |
| t (hrs) | Voltage | Pulsed-Voltage | Voltage | Pulsed-Voltage |
| 0-0.5 | 43% | 42% | 56 | 9.1 |
| 0.5-2 | 90% | 79% | 91 | 25.1 |
| 2-8 | 98.5% | 98% | 363 | 53.8 |
| 8-24 | 99.5% | 99.0% | 2049 | 576.2 |

### Working Example VI

This example compares the PFOS destruction performance of constant voltage (anodic voltage=8 V) and pulsed-voltage (peak voltage=8 V, duty cycle=4%, frequency=96 Hz) electrochemical oxidative destruction of PFOS over time. Experiments were conducted in the multi-pass reactor set-up of FIG. 2 using 8 liters of the electrolyte composition of Table V and a flow rate of 4 GPM. Experiments were run for 24 hours and aliquots of solution for HPLC/MS/MS analysis were collected before each trial and after 30 minutes, 2 hours, 8 hours, and 24 hours of treatment. Experimental results are summarized in Table VIII.

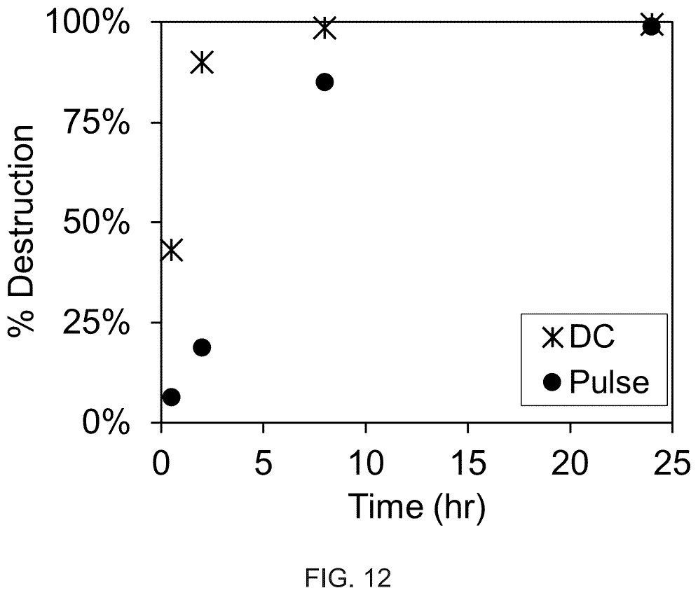

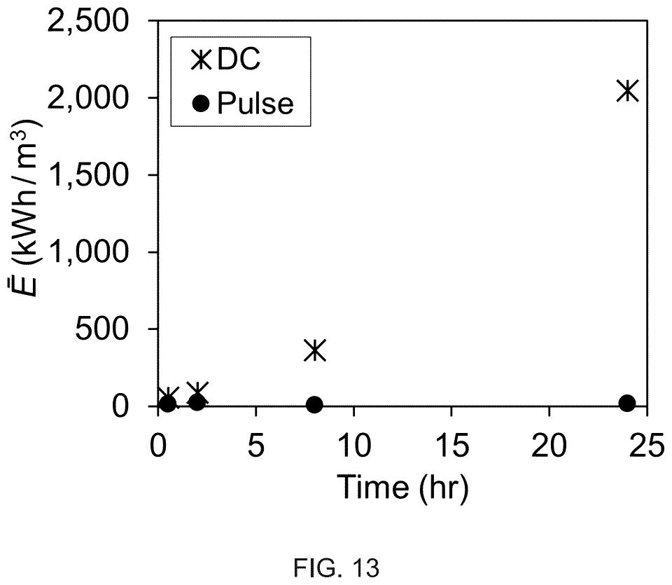

FIG. 12 shows how % Destruction varies as a function of time for the constant voltage and pulsed-voltage experiments. FIG. 13 shows how Ē varies as a function of time for the constant voltage and pulsed-voltage experiments. At early timepoints, constant voltage electrochemical oxidation achieves substantially higher % Destruction than the pulsed-voltage electrochemical oxidation (43% and 90% after 30 minutes and 2 hours for constant voltage electrochemical oxidation vs 6% and 13% after 30 minutes and 2 hours for the pulsed-voltage electrochemical oxidation). However, after 24 hours, both constant voltage and pulsed-voltage electrochemical oxidation had achieved ≥99% PFOS destruction and the Ē to achieve this % Destruction was 120× lower for the pulsed-voltage electrochemical oxidation (17.1 kWh/m³) relative to the DC waveform (2049 kWh/m³). These results demonstrate that, after 24 hours of electrochemical oxidation, pulsed-voltage (peak voltage=8 V, duty cycle=4%, frequency=96 Hz) can achieve a comparable % Destruction as 8 V constant voltage electrochemical oxidation with a substantially lower Ē.

TABLE VIII
Results for long-timescale experiments in which PFOS
destruction performance was monitored as a function of time
at a constant voltage (8 V) and using a pulsed-voltage (8 V,
duty cycle = 20%, frequency = 80 Hz). All experiments were
conducted in the multi-pass reactor set-up of FIG. 2, used 7 L
of the electrolyte composition of Table V, and employed a
constant a constant flow rate (4 GPM).

| | % Destruction | | Ē (kWh/m³) | |
|---|---|---|---|---|
| | Constant | | Constant | |
| t (hrs) | Voltage | Pulsed-Voltage | Voltage | Pulsed-Voltage |
| 0-0.5 | 43% | 6% | 56 | 15.2 |
| 0.5-2 | 90% | 13% | 91 | 25.7 |
| 2-8 | 98.5% | 84% | 363 | 8.1 |
| 8-24 | 99.5% | 99.0% | 2049 | 17.1 |

### Working Example VII

This example compares the % Destruction and Ē for constant voltage and pulsed-voltage electrochemical oxidative destruction for a mix of six PFAS (PFOS, PFOA, PFBS, PFHxS, PFNA, and HFPO-DA) using an anodic voltage of 8 V. Pulsed-voltage electrochemical oxidation used a duty cycle of 50%, frequency of 10 Hz, and applied a low anodic current (0.18 A) during the off-time. Experiments were conducted in a small-volume jar cell consisting of a 500-mL glass jar equipped with a glass stir bar (stir rate=400 rpm) and covered by a plastic lid. The small-volume jar cell used a boron doped diamond plate anode (active electrode area=15 cm²) and titanium mesh cathode. Electrical connection was made to the anode and cathode via titanium plates. An anode-to-cathode distance of 1.6 mm was maintained using plastic spacers. Experiments used 400 mL of aqueous electrolyte with 42 mM sodium sulfate, 2.5% methanol, and roughly equal concentrations of all six PFAS (5,000,000-10,000,000 ppt, show in Table IX). Trials were run for 48 hours and the concentration of PFAS was quantified before and after each trial using HPLC/MS/MS.

Experimental results from the DC and pulsed-voltage trial are summarized in Table IX. After 48 hours, % Destruction of ≥99.9% was achieved for all PFAS during both the constant voltage and pulsed-voltage experiments. Ē was calculated (per the equation described above) using the sum of the concentration for PFOS, PFOA, PFBS, PFHxS, PFNA, and HFPO-DA before the experiment (C₀) and after 48 hours of treatment (C_{f}). The Ē for pulsed-voltage electrochemical oxidation (546.2 kWh/m³) was 28% lower than that for constant voltage electrochemical oxidation (759.5 kWh/m³). These results demonstrate that pulsed-voltage electrochemical oxidation with a peak voltage of 8 V can achieve comparable % Destruction and lower Ē than constant voltage electrochemical oxidation at 8 V when working in mixed PFAS solutions.

TABLE IX
Results for DC and pulsed-voltage electrochemical
oxidative destruction for a mix of six PFAS
(PFOS, PFOA, PFBS, PFHxS, PFNA, and HFPO-DA) using
an anodic voltage of 8 V. Pulsed-voltage electrochemical
oxidation used a duty cycle of 50%, frequency of 10 Hz,
and applied a low anodic current (0.18 A) during the off-time.
Trials conducted in a small-volume jar cell using 0.4 L
of electrolyte (42 mM sodium sulfate, 2.5% methanol).
A stir bar (400 rpm) was used to promote solution flow.
Results include the initial concentration (C₀),
concentration after 48 hours (C_{f}), and %
Destruction for PFOS, PFOA, PFBS, PFHxS, PFNA, and HFPO-DA.
Ē calculated using the sum of the concentration
for PFOS, PFOA, PFBS, PFHxS, PFNA, and HFPO-DA.

| | Constant Voltage | | | Pulsed-Voltage | | |
|---|---|---|---|---|---|---|
| PFAS | C₀ (ppt) | C_{f} (ppt) | % Destruction | C₀ (ppt) | C_{f} (ppt) | % Destruction |
| PFOA | 9600000 | 650 | 99.99% | 9700000 | 460 | 99.99% |
| PFNA | 8600000 | 1000 | 99.99% | 7900000 | 2700 | 99.97% |
| PFBS | 8100000 | 3300 | 99.96% | 8100000 | 1400 | 99.98% |
| PFHxS | 8200000 | 1100 | 99.99% | 8500000 | 420 | 99.99% |
| PFOS | 5200000 | 4600 | 99.91% | 5100000 | 5300 | 99.90% |
| HFPO-DA | 7700000 | 0 | 100.00% | 7700000 | 0 | 100.00% |

| | | |
|---|---|---|
| Ē (kWh/m³) | 759.5 | 546.2 |

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. An electrochemical oxidative method of destroying recalcitrant contaminants in an aqueous solution, the method comprising:
directing the aqueous solution to an electrochemical reactor with an anode and a cathode;
delivering a pulsating voltage across the anode and cathode generating a pulsating current to decrease energy consumption;
urging the recalcitrant contaminants in the aqueous solution to contact the anode; and
breaking strong bonds of the recalcitrant contaminants when they contact the anode.

2. The method of claim 1 further including reversing the pulsating voltage to clean the anode.

3. The method of claim 1 in which the pulsating voltage has a voltage amplitude of between 5-20 Volts, duty cycles of between 10-50%, and a frequency of between 5-200 Hz.

4. The method of claim 1 in which said recalcitrant contaminants include per- and polyfluoroalkyl substances (PFAS) including perfluorooctane sulfonate (PFOS), perfluorooctanoic Acid (PFOA), perfluorobutane sulfonate (PFBS), perfluorohexane sulfonate (PFHxS), perfluorononanoic acid (PFNA), AND hexafluoropropylene oxide dimer acid (HFPO-DA) and other harmful organics contaminants including pharmaceuticals released from manufacturing processes, waste storage and treatment sites, present as aqueous solutions including solutions used to remove recalcitrant contaminants from contaminated solid media.

5. The method of claim 1 in which the pulsating voltage has a duty cycle of between 10-50%.

6. The method of claim 1 in which the pulsating voltage has a voltage amplitude of between 5-20V.

7. The method of claim 1 in which the pulsating voltage has a frequency of between 5-200 Hz.

8. An electrochemical oxidative method of destroying recalcitrant contaminants in an aqueous solution, the method comprising:
directing the aqueous solution to an electrochemical reactor with an anode and a cathode;
delivering a pulsating voltage across the anode and cathode generating a pulsating current to decrease energy consumption, said pulsating voltage having a voltage amplitude of between 5-20 Volts, duty cycles of between 10-50%, and a frequency of between 5-200 Hz;
urging the recalcitrant contaminants in the aqueous solution to contact the anode; and
breaking strong bonds of the recalcitrant contaminants when they contact the anode.

9. The method of claim 8 further including reversing the pulsating voltage to clean the anode.

10. The method of claim 8 in which said recalcitrant contaminants include per- and polyfluoroalkyl substances (PFAS) including perfluorooctane sulfonate (PFOS), perfluorooctanoic Acid (PFOA), perfluorobutane sulfonate (PFBS), perfluorohexane sulfonate (PFHxS), perfluorononanoic acid (PFNA), AND hexafluoropropylene oxide dimer acid (HFPO-DA) and other harmful organics contaminants including pharmaceuticals released from manufacturing processes, waste storage and treatment sites, present as aqueous solutions including solutions used to remove recalcitrant contaminants from contaminated solid media.
